(19) United States
(12) Patent Application Publication
(10) Pub. No.: US 2023/0050387 A1
(43) Pub. Date: Feb. 16, 2023

(54) METHOD AND SYSTEM FOR IMPOSING CONSTRAINTS IN A SKILL-BASED AUTONOMOUS SYSTEM

(71) Applicant: Siemens Aktiengesellschaft, Munich (DE)

(72) Inventors: Juan L. Aparicio Ojea, Moraga, CA (US); Heiko Claussen, Wayland, MA (US); Ines Ugalde Diaz, Redwood City, NJ (US); Martin Sehr, Kensington, CA (US); Eugen Solowjow, Berkeley, CA (US); Chengtao Wen, Redwood City, CA (US); Wei Xi Xia, Daly City, CA (US); Xiaowen Yu, Union City, CA (US); Shashank Tamaskar, Mohali, Punjab (IN)

(21) Appl. No.: 17/794,065

(22) PCT Filed: Feb. 11, 2020
(86) PCT No.: PCT/US2020/017702

§ 371 Date: Jul. 20, 2022

(51) Int. Cl. G05B 19/418

(52) U.S. Cl. CPC G05B 19/41835; G05B 2219/31368

(57) ABSTRACT

According to an aspect of the present disclosure, a computer-implemented includes creating a plurality of basic skill functions for a controllable physical device of an autonomous system. Each basic skill function includes a functional description for using the controllable physical device to interact with a physical environment to perform a defined objective. The method further includes selecting one or more basic skill functions to configure the controllable physical device to perform a defined task. The method also includes determining a decorator skill function specifying at least one constraint. The decorator skill function is configured to impose, at run-time, the at least one constraint, on the one or more basic skill functions. The method further includes generating executable code by applying the decorator skill function to the one or more basic skill functions, and actuating the controllable physical device using the executable code.

### BACKGROUND

### 1. Field

The present disclosure relates generally to engineering autonomous systems, and in particular, to a technique for imposing constraints in a skill-based autonomous system.

### 2. Description of the Related Art

The requirement to manage rapid innovation cycles, complex customization requirements, and growing cost pressures in a global and highly competitive landscape presents a growing challenge to traditional industrial automation systems. This challenge is motivating a trend for manufacturers to gradually transition from automation to autonomy. In contrast to automation, autonomy gives each asset on the factory floor the decision-making and self-controlling abilities to act independently in the event of local issues.

The industrial use cases for autonomous systems on a factory floor are expected to be wide-spread and cover a large range of application scenarios. In some use cases, this may involve the need to reduce or even remove human involvement. In other scenarios, autonomous machines may augment factory workers' physical and intellectual abilities. This development is a core enabling technology for flexible manufacturing operations as envisioned in the context of Industry 4.0.

It is envisioned that engineering tools for autonomous systems would need to cope with novel programming paradigms challenging the state of the art in industrial automation systems.

### SUMMARY

Briefly, aspects of the present disclosure are directed to techniques for imposing constraints in engineering autonomous systems, in a skill-based programming paradigm.

According to one aspect of the present disclosure, a computer-implemented method is provided. The method comprises creating a plurality of basic skill functions for a controllable physical device of an autonomous system. Each basic skill function comprises a functional description for using the controllable physical device to interact with a physical environment to perform a skill objective. The method further comprises selecting one or more basic skill functions, from the plurality of basic skill functions, to configure the controllable physical device to perform a defined task. The method further comprises determining a decorator skill function specifying at least one constraint. The decorator skill function is configured to impose, at run-time, the at least one constraint, on the one or more basic skill functions. The method further comprises generating executable code by applying the decorator skill function to the one or more basic skill functions. The method further comprises actuating the controllable physical device using the executable code.

Other aspects of the present disclosure implement features of the above-described method in computing systems and computer program products.

Additional technical features and benefits may be realized through the techniques of the present disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The foregoing and other aspects of the present disclosure are best understood from the following detailed description when read in connection with the accompanying drawings. To easily identify the discussion of any element or act, the most significant digit or digits in a reference number refer to the figure number in which the element or act is first introduced.

FIG. 1 is a block diagram of an example of a computing system where aspects of the present disclosure may be implemented.

FIG. 2 is a block diagram illustrating functional modules of an engineering tool for programming an autonomous robot to carry out a task.

FIG. 3 graphically illustrates the execution of an example task by an autonomous robot based on basic skill functions.

FIG. 4 graphically illustrates the execution of an example task using a safety decorator skill function to modify a behavior of the autonomous robot.

FIG. 5 is a flowchart illustrating a method for imposing constraints in engineering an autonomous system according to an embodiment of the present disclosure.

### DETAILED DESCRIPTION

Aspects of the present disclosure described below relate to engineering an autonomous system in a skill-based programming paradigm. In conventional automation, an automated robot is typically programmed to perform a single, repetitive task, such as positioning a car panel in exactly the same place on each vehicle. In this case, an engineer is usually involved in programming an entire task from start to finish, typically utilizing low-level code to generate individual commands. In the presently described autonomous system, an autonomous device, such as a robot, is programmed at a higher level of abstraction using skills instead of individual commands.

For programming in the skill-based paradigm, one starts from the standpoint of graphical editing and builds on top. In this case, an engineer would generally know what they want the robot to do and the attributes of how the job should be accomplished but is less likely to know how to accomplish the task or know how various implementation choices will interact with each other. So, a large part of the engineer's job is selecting and arranging the skills required for a defined task.

The present inventors recognize that, by abstracting specific robot commands into skills, an engineer may lose knowledge of the behavior of the robot for a specific input. Specific machine motion patterns may be deliberately less transparent to engineers, who do not design low-level robot tasks, e.g. path planning or collision avoidance. Instead, engineers of autonomous systems would primarily focus on high-level system and application properties, e.g., goals and skill objectives. This poses the challenge in encoding modifiable constraints in an engineering tool used to program autonomous devices.

Embodiments of the present disclosure address at least the afore-mentioned technical challenges and provide a technique for imposing constraints in a skill-based autonomous system. A non-limiting example application of the present disclosure includes imposing safety constraints in an autonomous system. In an autonomous environment, it is desirable that safety is intrinsic and built into systems implicitly. The present technique would ensure that every action executed by an autonomous device, such as a robot, takes safety constraints into account, without modifying the programmed skills.

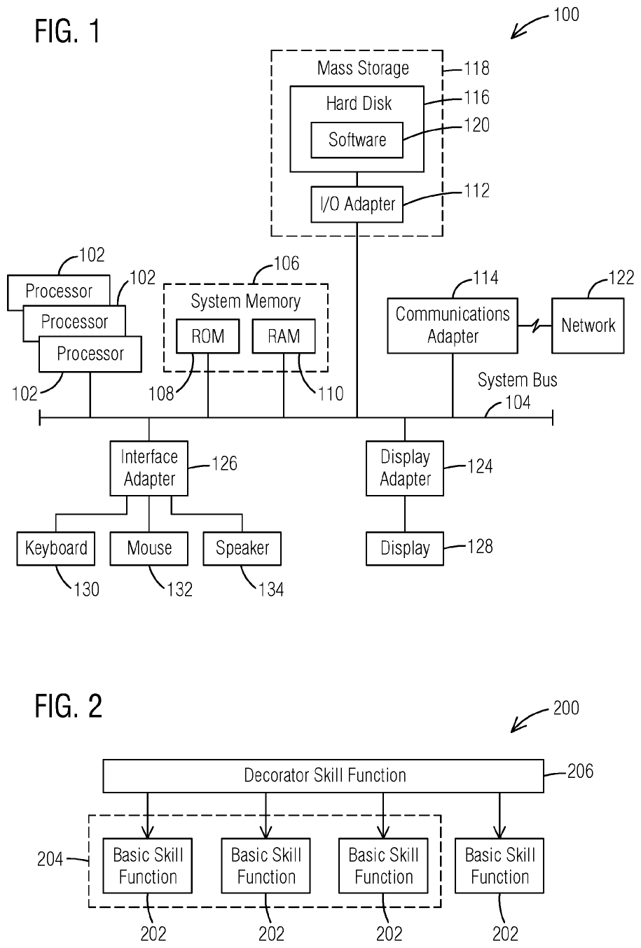

Turning now to FIG. 1, a computing system 100 is generally shown wherein aspects of the present disclosure may be implemented. The computing system 100 can be an electronic, computer framework comprising and/or employing any number and combination of computing devices and networks utilizing various communication technologies. The computing system 100 may be easily scalable, extensible, and modular, with the ability to change to different services or reconfigure some features independently of others. The computing system 100 may be, for example, a server, desktop computer, laptop computer, tablet computer, or smartphone. In some examples, the computing system 100 may be comprise a programmable logic controller (PLC) or an embedded device associated with an industrial robot. In some examples, computing system 100 may be a cloud computing node. In some examples, the computing system 100 may comprise an edge computing device.

Computing system 100 may be described in the general context of computer executable instructions, such as program modules, being executed by a computing system. Generally, program modules may include routines, programs, objects, components, logic, data structures, and so on that perform particular tasks or implement particular abstract data types. Computing system 100 may be practiced in distributed cloud computing environments where tasks are performed by remote processing devices that are linked through a communications network. In a distributed cloud computing environment, program modules may be located in both local and remote computing system storage media including memory storage devices.

As shown in FIG. 1, the computing system 100 has one or more processors 102, which may include, for example, one or more central processing units (CPU), graphics processing units (GPU), or any other processor known in the art. The processors 102 can be a single-core processor, multi-core processor, computing cluster, or any number of other configurations. The processors 102, also referred to as processing circuits, are coupled via a system bus 104 to a system memory 106 and various other components. The system memory 106 can include a read only memory or ROM 108 and a random access memory or RAM 110 110. The ROM 108 is coupled to the system bus 104 and may include a basic input/output system (BIOS), which controls certain basic functions of the computing system 100. The RAM 110 is read-write memory coupled to the system bus 104 for use by the processors 102. The system memory 106 provides temporary memory space for operations of said instructions during operation. The system memory 106 can include random access memory (RAM), read only memory, flash memory, or any other suitable memory systems.

The computing system 100 comprises an I/O adapter 112 (input/output adapter) and a communications adapter 114 coupled to the system bus 104. The I/O adapter 112 may be a small computer system interface (SCSI) adapter that communicates with a hard disk 116 and/or any other similar component. The I/O adapter 112 and the hard disk 116 are collectively referred to herein as a mass storage 118.

Software 120 for execution on the computing system 100 may be stored in the mass storage 118. The mass storage 118 is an example of a tangible storage medium readable by the processors 102, where the software 120 is stored as instructions for execution by the processors 102 to cause the computing system 100 to operate, such as is described herein below with respect to the various Figures. Examples of computer program product and the execution of such instruction is discussed herein in more detail. The communications adapter 114 interconnects the system bus 104 with a network 122, which may be an outside network, enabling the computing system 100 to communicate with other such systems. In one embodiment, a portion of the system memory 106 and the mass storage 118 collectively store an operating system, which may be any appropriate operating system, to coordinate the functions of the various components shown in FIG. 1.

Additional input/output devices are shown as connected to the system bus 104 via a display adapter 124 and an interface adapter 126. In one embodiment, the I/O adapter 112, the communications adapter 114, the display adapter 124 and the interface adapter 126 may be connected to one or more I/O buses that are connected to the system bus 104 via an intermediate bus bridge (not shown). A display 128 (e.g., a screen or a display monitor) is connected to the system bus 104 by the display adapter 124, which may include a graphics controller to improve the performance of graphics intensive applications and a video controller. A keyboard 130, a mouse 132, a speaker 134, among other input/output devices, can be interconnected to the system bus 104 via the interface adapter 126, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI). Thus, as configured in FIG. 1, the computing system 100 includes processing capability in the form of the processors 102, and, storage capability including the system memory 106 and the mass storage 118, input means such as the keyboard 130 and the mouse 132, and output capability including the speaker 134 and the display 128.

In some embodiments, the communications adapter 114 can transmit data using any suitable interface or protocol, such as the internet small computing system interface, among others. The network 122 may be a cellular network, a radio network, a wide area network (WAN), a local area network (LAN), or the Internet, among others. An external computing device may connect to the computing system 100 through the network 122. In some examples, an external computing device may be an external webserver or a cloud computing node.

It is to be understood that the block diagram of FIG. 1 is not intended to indicate that the computing system 100 is to include all of the components shown in FIG. 1. Rather, the computing system 100 can include any appropriate fewer or additional components not illustrated in FIG. 1 (e.g., additional memory components, embedded controllers, modules, additional network interfaces, etc.). Further, the embodiments described herein with respect to computing system 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

FIG. 2 is a block diagram illustrating functional modules of an engineering tool 200 for programming an autonomous device to carry out a task. The engineering tool 200 may be implemented, for example, in conjunction with the computing system 100 illustrated in FIG. 1. The engineering tool 200, comprises a collection of basic skill functions 202 available for an engineer to program an autonomous physical device, such as a robot. Each basic skill function 202 is an individual programming block (also referred to as programming object or programming module), which comprises a functional description for using the robot to interact with a physical environment to perform a specific skill objective. The basic skill functions 202 may have both, a functional, as well as a structural component. The basic skill functions 202 are derived for higher-level abstract behaviors centered on how the environment is to be modified by the programmed physical device. Illustrative examples of basic skill functions 202 that may be implemented using the techniques described herein include a skill to open a door, a skill to detect an object, a skill to grasp and pick an object, a skill to place an object, and so on. A basic skill function 202 may be designated by activating it as a function within the programming environment. This may be performed, for example, by calling the basic skill function 202 as part of a device service. Once activated, the basic skill function 202 reads out structural information from the physical environment to determine its operation.

The engineering tool 200 may be designed to allow an engineer to program a robot to perform a defined task 204 by selecting one or more of the available basic skill functions 202. In one example embodiment, the engineering tool 200 may comprise a graphical user interface configured to allow an engineer to simply drag and drop basic skill functions 202 from a skill menu, and program the robot to perform the task 204 by setting appropriate task parameters.

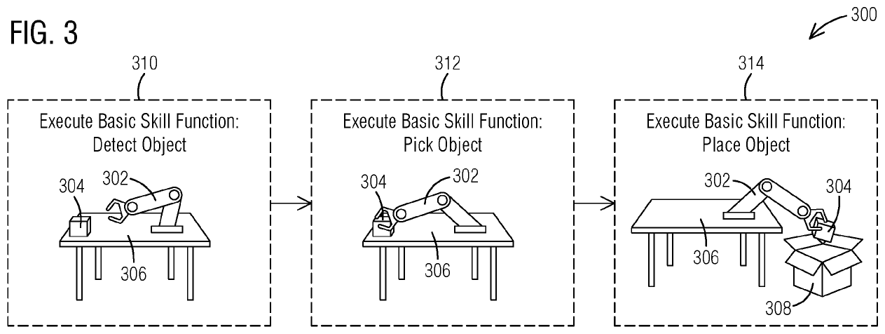

Referring to FIG. 3, an example task 300 is illustrated, which involves using a robot 302 to move an object 304 from a first position, namely a table 306 to a second position, namely a box 308. To program the robot 302 to execute the example task 300, an engineer may select three basic skill functions, namely “detect object”, “pick object” and “place object”, and set task parameters, such as size of the object 304, initial position of the object 304 on the table 306, position of the box 308, and so on. The blocks 310, 312 and 314 respectively depict the execution of the basic skill functions “detect object”, pick object” and place object“.

Referring back to FIG. 2, the engineering tool 200 further includes a decorator skill function 206, which is a separate programming block specifying at least constraint. The decorator skill function 206 is configured to impose, at run-time, the at least one constraint, on the basic skill functions 202. By imposing the constraint on the basic skill function 202, the behavior of the physical device, in this case the robot, may be modified at run-time, without disrupting the operation of the basic skill functions 202. Using a decorator skill function 206 allows the constraints to be applied on all basic skill functions 202 instead of being used in a sequence of actions. In the presently envisioned implementation, a decorator skill function 206 is designed analogous to a cross-cutting “concern” or “aspect” used in Aspect Oriented Programming (AOP). The decorator skill function 206 is thus configured to be orthogonal to the basic skill functions 202. Furthermore, the decorator skill function 206 may be modified, based on a user input, during engineering or at run-time, without modifying any of the basic skill functions 202.

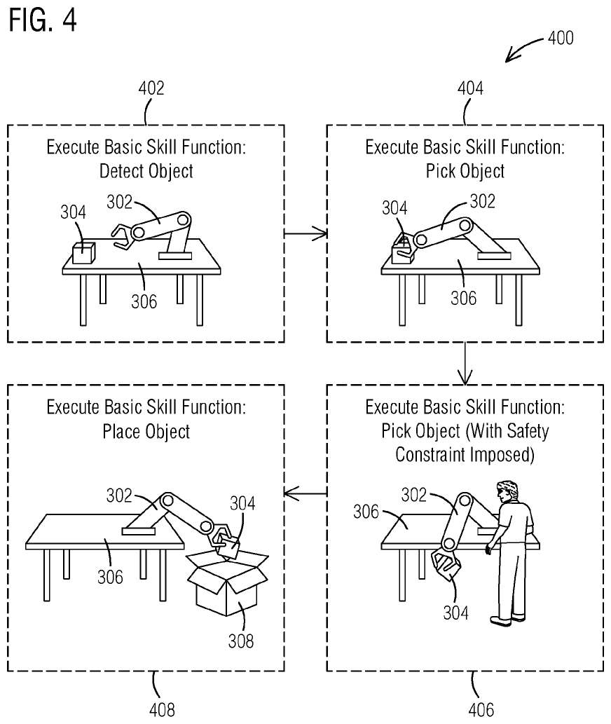

In one embodiment, as illustrated hereinafter referring to FIG. 4, the decorator skill function may be a safety decorator skill function. In this case, the constraints, which may be time-variant, specified by the safety decorator skill function, may be superimposed to, and removed from, a basic skill function dynamically at run-time and allow modifications of robot or machine behavior without adjustments to the remaining code base. That is, an engineer may make a collection of basic skill functions available for use by an autonomous robot, which may then be equipped with an overarching safety skill, akin to a decorator in object-oriented programming. This technique offers very distinctive benefits over modifying the other, basic skill functions to impose safety requirements. For example, changes to safety requirements, either during engineering or at run-time, need only to be reflected in the safety decorator skill function. The above feature isolates basic behavior of the machine from potentially changing safety restrictions and keeps the code of the remaining basic skill functions lean. Furthermore, remaining skills (basic skill functions) may be designed independent from the safety skill, as it is superimposed. Additionally, this technique results in inherent treatment of safety as a system property that can be analyzed.

FIG. 4 illustrates the execution of an example task 400 using a safety decorator skill function to modify a behavior of the robot 302 to meet a safety objective. The example task 400 is, once again, to use the robot 302 to move an object 304 from a first position, namely a table 306 to a second position, namely a box 308. To program the robot 302 to execute the example task 400, an engineer may again select three basic skill functions, namely “detect object”, “pick object” and “place object”, and set appropriate task parameters as mentioned above. However, in this example, the safety decorator skill function is configured to impose one or more safety constraints at run-time to modify a behavior of the robot 302, when a human is detected to be within a predefined proximity to the robot 302. The presence of a human within a predefined proximity to the robot 302 may be detected by a sensor, for example, a camera or a light barrier. To this end, the safety decorator skill function may be configured to continuously check for inputs from the sensor and provide a trigger, when a human is detected, to impose the safety constraints during execution of one or more basic skill functions.

Continuing with reference to FIG. 4, blocks 402 and 404 respectively depict the execution of the basic skill functions “detect object” and “pick object”. Block 406 depicts the execution of the basic skill function “pick object”. However, at this time, a human is detected to be in the proximity of the robot 302. Consequently, one or more safety constraints are autonomously called. Such safety constraints may include, for example, reducing a speed of movement of the robot, activating an advanced motion planner, activating a human-machine interface, among others. Block 408 depicts the execution of the basic skill function “place object”. At this time, there is no human detected in the proximity of the robot 302 and the safety constraints are removed.

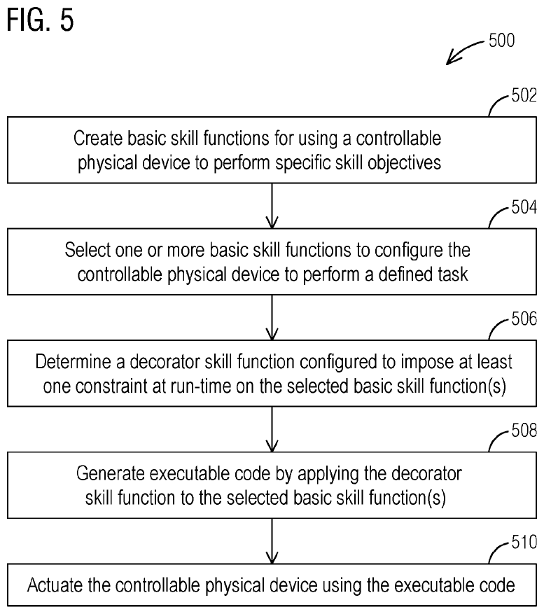

FIG. 5 is a flowchart illustrating a method 500 for imposing constraints in engineering an autonomous system according to an embodiment of the present disclosure. Block 502 of the method 500 involves creating a plurality of skill functions for a controllable physical device of an autonomous system. Each basic skill function comprises a functional description for using the controllable physical device to interact with a physical environment to perform a skill objective. Block 504 of the method 500 involves selecting one or more basic skill functions, from the plurality of basic skill functions, to configure the controllable physical device to perform a defined task. The one or more basic skill functions may be selected based on a user input. Block 506 of the method 500 involves determining a decorator skill function specifying at least one constraint. The decorator skill function is configured to dynamically impose, at run-time, the at least one constraint, on the one or more basic skill functions. At block 508 of the method 500, an executable code is generated by applying the decorator skill function to the selected one or more basic skill functions. Block 510 of the method 500 involves actuating the controllable physical device using the executable code. The process flow depicted in FIG. 5 is not intended to indicate that the operational blocks of the method 500 are to be executed in any particular order. Additionally, the method 500 can include any suitable number of additional operational blocks.

The at least one constraint may be imposed in a time-variant manner, or in an uninterrupted manner, at run-time. In one embodiment, the decorator skill function is configured to impose the at least one constraint at run-time responsive to a predefined trigger. Furthermore, the decorator skill function may be configured to remove the at least one constraint at run-time when the predefined trigger is removed. In the example illustrated in FIG. 4, the detection of a human within a predefined proximity to the robot provides a trigger to impose the safety constraints. The behavior of the robot is thereby modified in proximity to a human, to achieve a safety objective. The safety constraints are removed when the above-mentioned trigger is removed, that is, then a human is no longer detected within the predefined proximity to the robot. In one embodiment, the decorator skill function may be modified, based on a user input during engineering or at run-time, to specify a new constraint in the decorator skill function and/or remove an existing constraint specified in the decorator skill function, to thereby modify a behavior of the controllable physical device without modifying the one or more basic skill functions.

It should be appreciated that aspects of the present disclosure are not limited, in implementation, to robots, but may extend to other types of autonomous devices. For example, in one embodiment, such an autonomous device may comprise an autonomous vehicle. In this case, a basic skill function may comprise, for example, performing a specific maneuver, on which a safety (or other) aspect may be imposed by way of a decorator skill function as described herein. It should also be appreciated that while a decorator skill function may be configured to impose a constraint (at run-time) on each of the basic skill functions, a decorator skill function may not be always necessary to define a task, and may not be applied to tasks that do not require constraints.

Furthermore, aspects of the present disclosure are not limited to safety and may be extended to superimpose other overarching aspects on basic skill functions. In one embodiment, the decorator skill function may comprise a hardware decorator skill function. In a hardware decorator skill function, the constraints may be specified based on a type of computing platform used to execute the code. For example, a hardware decorator skill function may specify constraints that reflect the ability to execute certain functionalities on an edge computing device versus a cloud computing platform, or may reflect computing resource allocation, such as adjusting the number of CPUs/GPUs made available to execute the code. In one embodiment, the decorator skill function may comprise a communications decorator skill function. In a communications decorator skill function, the constraints may be specified based on a type of communications architecture used for communication between entities of the autonomous system. This is applicable, for example, in autonomous systems comprising multiple devices (such as robots) communicating with each other. In this case, the constraints may specify, for example, communication ports and/or communication protocols used by the devices. In one embodiment, the engineering tool may comprise multiple decorator skill functions, such as safety, hardware, communications, etc., each configured to impose one or more constraints at run-time to the basic skill functions, to modify the behavior of an autonomous device, without affecting the basic skill functions.

Using a decorator skill function allows an engineer to separate the high-level skill objectives of a program or app (e.g. pick and place objects) from overarching aspects such as safe execution and architecture, device hardware configuration and communications architecture. This allows, for instance, modifying execution times of certain program components or skill functions, such as when having a human close to the robot or changing a robot model or add/remove safety constraints to one with different safety characteristics, without modifying the overall functionality captured in the program or app.

The technique disclosed herein may lead to modular architecture, lightweight software, and user-friendliness. This is anticipated to significantly impact current trends such as skill-based programming of autonomous systems. Furthermore, robot user interface, menus and options may look completely different by simply adding an aspect (such as safety, hardware configuration, communications architecture, etc.) to a given program.

Aspects of the present disclosure may include a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

An executable code, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A graphical user interface (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

The functions and process steps herein may be performed automatically, wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the disclosure to accomplish the same objectives. Although this disclosure has been described with reference to particular embodiments, it is to be understood that the embodiments and variations shown and described herein are for illustration purposes only. Modifications to the current design may be implemented by those skilled in the art, without departing from the scope of the disclosure.

What is claimed is:

1. A computer-implemented method comprising:
creating a plurality of basic skill functions for a controllable physical device of an autonomous system, each basic skill function comprising a functional description for using the controllable physical device to interact with a physical environment to perform a skill objective,
selecting one or more basic skill functions, from the plurality of basic skill functions, to configure the controllable physical device to perform a defined task,
determining a decorator skill function specifying at least one constraint, the decorator skill function being configured to impose, at run-time, the at least one constraint, on the one or more basic skill functions,
generating executable code by applying the decorator skill function to the one or more basic skill functions, and
actuating the controllable physical device using the executable code.

2. The method of claim 1, wherein the decorator skill function is configured to impose the at least one constraint at run-time responsive to a predefined trigger.

3. The method of claim 2, wherein the decorator skill function is configured to remove the at least one constraint at run-time when the predefined trigger is removed.

4. The method of claim 1, further comprising modifying the decorator skill function, based on a user input, to specify a new constraint in the decorator skill function and/or remove an existing constraint specified in the decorator skill function, to thereby modify a behavior of the controllable physical device without modifying the one or more basic skill functions.

5. The method of claim 4, wherein the decorator skill function is modified at run-time.

6. The method of claim 4, wherein the decorator skill function is modified during engineering of the autonomous system.

7. The method of claim 1, wherein the decorator skill function comprises a safety decorator skill function.

8. The method of claim 7, wherein the safety decorator skill function is configured to impose the at least one constraint at run-time to modify a behavior of the controllable physical device, when a human is detected to be within a predefined proximity to the physical device.

9. The method of claim 1, wherein the decorator skill function comprises a hardware decorator skill function, wherein the at least one constraint is specified based on a type of computing platform used to execute the code.

10. The method of claim 1, wherein the decorator skill function comprises a communications decorator skill function, wherein the at least one constraint is specified based on a type of communications architecture used for communication between multiple devices of the autonomous system.

11. A computing system comprising:
a processor; and
a memory storing instructions that, when executed by the processor, configure the computing system to:
create a plurality of basic skill functions for a controllable physical device of an autonomous system, each basic skill function comprising a functional description for using the controllable physical device to interact with a physical environment to perform a skill objective,
select one or more basic skill functions, from the plurality of basic skill functions, to configure the controllable physical device to perform a defined task,
determine a decorator skill function specifying at least one constraint, the decorator skill function being configured to impose, at run-time, the at least one constraint, on the one or more basic skill functions,
generate executable code by applying the decorator skill function to the one or more basic skill functions, and
actuate the controllable physical device using the executable code.

12. The computing system of claim 11, wherein the decorator skill function is configured to impose the at least one constraint at run-time responsive to a predefined trigger.

13. The computing system of claim 12, wherein the decorator skill function is configured to remove the at least one constraint at run-time when the predefined trigger is removed.

14. The computing system of claim 11, wherein the decorator skill function comprises a safety decorator skill function.

15. The computing system of claim 14, wherein the safety decorator skill function is configured to impose the at least one constraint at run-time to modify a behavior of the controllable physical device, when a human is detected to be within a predefined proximity to the physical device.

16. The computing system of claim 11, wherein the decorator skill function comprises a hardware decorator skill function, wherein the at least one constraint is specified based on a type of computing platform used to execute the code.

17. The computing system of claim 11, wherein the decorator skill function comprises a communications decorator skill function, wherein the at least one constraint is specified based on a type of communication architecture used for communication between multiple devices of the autonomous system.

18. A non-transitory computer-readable storage medium, the computer-readable storage medium including instructions that when executed by a computer, cause the computer to:
create a plurality of basic skill functions for a controllable physical device of an autonomous system, each basic skill function comprising a functional description for using the controllable physical device to interact with a physical environment to perform a skill objective,
select one or more basic skill functions, from the plurality of basic skill functions, to configure the controllable physical device to perform a defined task,
determine a decorator skill function specifying at least one constraint, the decorator skill function being configured to impose, at run-time, the at least one constraint, on the one or more basic skill functions,
generate executable code by applying the decorator skill function to the one or more basic skill functions, and
actuate the controllable physical device using the executable code.

19. The non-transitory computer-readable storage medium of claim 18, wherein the decorator skill function is configured to impose the at least one constraint at run-time responsive to a predefined trigger.

20. The non-transitory computer-readable storage medium of claim 19, wherein the decorator skill function is selected from the set consisting of: a safety decorator skill function, a hardware decorator skill function and a communications decorator skill function.
